(19) United States
(12) Patent Application Publication
(10) Pub. No.: US 2004/0040086 A1
(43) Pub. Date: Mar. 4, 2004

(54) Healthcare system with coordinated operation of sub-systems

(76) Inventors: David Eisenberg, Jerusalem (IL); Paul Verhaert, Antwerp (BE)

Correspondence Address: Dekel Patent Ltd., Beit HaRofim, Room 27, 18 Menuha VeNahala Street, Rehovot, IL

(21) Appl. No.: 10/232,513

(22) Filed: Sep. 3, 2002

(51) Int. Cl. A61G 7/10

(52) U.S. Cl. 5/81.1 R

(57) ABSTRACT

A healthcare system comprising a patient transporter adapted to move a patient, a patient assist device adapted to perform an assistive action for a physically challenged patient, and a controller in communication with the patient transporter and the patient assist device, adapted to coordinate interaction of the patient transporter with the patient assist device.

### FIELD OF THE INVENTION

The present invention relates generally to healthcare systems, and particularly to a healthcare system that coordinates operations of sub-systems to move and provide healthcare to a patient, e.g., invalids, handicapped persons, elderly persons and physically challenged persons.

### BACKGROUND OF THE INVENTION

Many kinds of healthcare systems have been developed for providing healthcare related services to patients, such as invalids, handicapped persons, elderly persons and physically challenged persons.

For example, there are many kinds of patient transportation devices, including vertical lifting machines with linear and rotary motion, carrying devices for moving the patient from one place to another, and devices for lifting a patient from a sitting or lying position to a standing position and vice versa.

In the patent literature, U.S. Pat. No. 5,630,236 describes a lavatory assistance device for supporting and assisting persons having difficulty in sitting or standing. A cradle supports a user under the armpits. The user controls lowering, stopping or raising actions by operating a control having handles which are placed in front of the cradle.

British Patent GB-A-2140773 describes a device comprising a frame, a cradle comprising a backrest to which arms are connected which are engageable under the armpits to support the handicapped person by the armpits during the entire movement between the standing and seated position and the reverse movement

U.S. Pat. No. 4,031,576 describes patient lifting apparatus comprising a frame having a seat and two armrests linked to a motor means.

PCT Published Patent Application WO 84/02074 describes a device that supports a person under the armpits, under the thighs and at the back, and which lowers or raises the person who remains seated.

French Patents FR-A-1481626 and FR-A-2337547 describe a mobile seat to move a person from a seated position to a standing position. The described devices are purported to have the capability of lowering and raising a seated person.

U.S. Pat. No. 6,006,377 describes a patient carrying device that carries a patient between various locations, for example, bed, toilet and bathtub. The patient carrying device comprises a pair of mobile vehicles, each capable of freely running along rails and powered by motors.

U.S. Pat. No. 5,809,591 describes a transverse bar which carries a patient lift system for movement between two laterally extending bars. The transverse bar is mounted at the same vertical height as the laterally extending bars and carries a motor for lifting and lowering the patient.

The above examples belong to the broad family of healthcare systems that move the patient. Another family of healthcare systems includes devices that move in relation to the patient, examples of which are now described.

Mobile lavatory units are known. For example, vertically adjustable lavatories are disclosed in U.S. Pat. No. 1,060,106 (McGregor), U.S. Pat. No. 1,391,091 (Arbuckle), U.S. Pat. No. 2,716,757 (Erikson), U.S. Pat. No. 2,817,094 (Lessley), U.S. Pat. No. 3,011,177 (Haughhey), U.S. Pat. No. 3,118,147 (Larkin), U.S. Pat. No. 3,456,264 (Flagg), U.S. Pat. No. 3,473,173 (Maciulaitis), U.S. Pat. No. 3,486,175 (Schwartz), U.S. Pat. No. 3,502,384 (Gipson), U.S. Pat. No. 4,233,693 (Stocklow), and U.S. Pat. No. 5,628,075 (Dudnick, et al.).

U.S. Pat. No. 5,23,109 describes a vertically adjustable lavatory assembly, comprising an outer frame and a carrier frame positioned within the outer frame. The carrier frame is vertically moveable within the outer frame and has a lavatory connected thereto. A lavatory is positioned outside the carrier frame and outer frame, and includes a faucet and a sink basin having an outlet opening therein. A drain line is in fluid flow communication with the sink basin outlet opening and a sewer line, and is adapted to accommodate for changes in the height of the sink basin. A plurality of supply lines are provided for supplying water to the faucet. The supply lines are also adapted to accommodate for changes in the height of the basin.

Other lavatories have been described which are vertically adjustable by hand operated jacks, hydraulic pressure, electric motors, and/or various other types of mechanical devices, gears, and linkages. The drain lines of such systems are typically flexible or telescoping to accommodate for the vertical movement of the sink.

Vertically adjustable toilets are also known. For example, U.S. Pat. No. 6,199,228 describes a height adjustable toilet seat including a frame member disposed on opposing sides of a toilet. The frame member has sliding plates with a toilet seat secured therebetween, whereby the toilet seat is positioned over a toilet bowl. A water supply conduit is provided that is coupled with a standard water supply line.

U.S. Pat. No. 5,063,617 discloses the use of household water pressure to raise and lower a toilet seat for use by disabled people.

U.S. Pat. No. 4,726,079 describes a height adjustable toilet bowl, including a water actuated cylinder for moving it between a low position and a high position, and a cleaning water circuit connected to a water supply pipe.

U.S. Pat. No. 4,091,473 describes an adjustable toilet mounted on the wall of a bathroom. The toilet is raised and lowered by an electrically driven motor. The toilet provides electrical limit switches for stopping the motor at a desired height above the bathroom floor.

### SUMMARY OF THE INVENTION

The present invention seeks to provide a novel healthcare system, which may provide a multiplicity of semi-independent, complementary capabilities and functionalities for assisting a physically challenged person. In most general terms, without limiting the scope of the invention, the present invention seeks to coordinate the operation and functionality of different sub-systems of a healthcare system, integrating moving the patient with caring for some other needs of the patient in a most user-friendly manner.

For example, the healthcare system of the present invention may be employed to lift and support a patient sitting or lying in bed, while performing various healthcare related activities, such as but not limited to, rearranging the patient's pillows or washing the patient's back or other body parts.

In another example, the healthcare system of the present invention may comprise an adjustable sink uniquely suited to the needs of a frail patient. For example, the sink of the present invention may be moved vertically to adjust to the height of the patient. The sink may be moved (e.g., horizontally) towards a patient who is in a sitting position, so as to obviate the need for the patient to rise to a standing or semi-standing position. In another example, if the patient approaches the sink while standing, the sink may automatically adjust its position so that the patient may sit down next to or in front of the sink, thereby permitting the patient to use bathroom or toilet facilities with the outmost convenience and remain in close functional proximity to the sink.

The healthcare system of the invention may comprise one or more support members that support the patient, such as from behind on the patient's back, whether in a sitting or standing position with respect to the sink, thereby preventing the patient from losing his/her balance while using the sink or other facilities nearby. Sensors may be provided in the system that sense the load on the support members and adjust the supportive forces applied to the patient. Interactive patient interfaces, described more in detail hereinbelow, may be provided that enable maneuvering the patient to and from the sink, in and out of the room, or into and out of a wheelchair, for example.

Different elements of the healthcare system may coordinate and combine their functionalities. For example, two patient transporters may cooperate to convey a patient to a wheelchair, with one transporter carrying the lower body parts, and the other transporter lifting the patient under the arms. In this example, the transporters work together, however, the transporters may work independently.

The healthcare system of the present invention may be operated by patient commands (e.g., manually operated or by voice commands), or may be sensitive to the current situation and operate accordingly even without a patient command. In other words, the system may learn certain situations, store them in memory, and be programmed to perform some required action in those situations. Moreover, the system may be sensitive to the permissibility of certain operations in certain situations, and “override” the patient's commands. For example, if the patient pushes a “wrong” button, or would like to perform an operation that does not match his/her physical capabilities, or issues a voice command physically inconsistent with the current situation, the system may override and not carry out the command to avoid damage to the patient or system.

As another example, if the healthcare system senses that the patient is too frail to do certain actions even with the help of the healthcare system, the healthcare system may inform the patient, such as by a voice message, that the requested action may require human assistance. The healthcare system may itself summon the human assistance. The human user would then decide how to proceed.

The system of the invention may thus comprise a multi-functional patient or patient-related transport, assistance and interface system which may execute user commands, but which may also comprise interactive constraints that require the user to consult with the system before execution of commands or which may override such commands, and an infrastructure of representative functions which may enable interaction between the user and the system, for greater sensitivity and control of the system operation.

The healthcare system may comprise a database of medical and personal information of users of the system. Each user may be identified by means of an identification number or code. The user may be issued an identification card, such as a smart card, which may be inserted in a card reader to gain access to the system and allow the system to identify the current user and adapt to that user's needs, limitations and preferences. The database and identification card may be updated to constantly meet the user's needs, limitations and preferences.

In an implementation of the healthcare system for a rest room, the system may automatically close the rest room entrance door and not allow another person in, unless the system detects a medical or life-threatening emergency. Upon the user's exit, the system may close and/or lock the door, and reset the system's components. The system may also wash and disinfect sanitary devices in the rest room, so that the rest room may appear as an ordinary rest room for standard use. In this manner, the system may avoid embarrassment and discomfort for the physically challenged patients.

### BRIEF DESCRIPTION OF THE DRAWINGS

The present invention will be understood and appreciated more fully from the following detailed description taken in conjunction with the appended drawings in which:

FIG. 1 is a simplified pictorial illustration of a healthcare system, constructed and operative in accordance with an embodiment of the present invention;

FIG. 2 is a simplified pictorial illustration of another embodiment of a healthcare system, constructed and operative in accordance with an embodiment of the present invention; and

FIG. 3 is a simplified block diagram of various modes of operation of the healthcare systems of the present invention.

### DETAILED DESCRIPTION OF THE PRESENT INVENTION

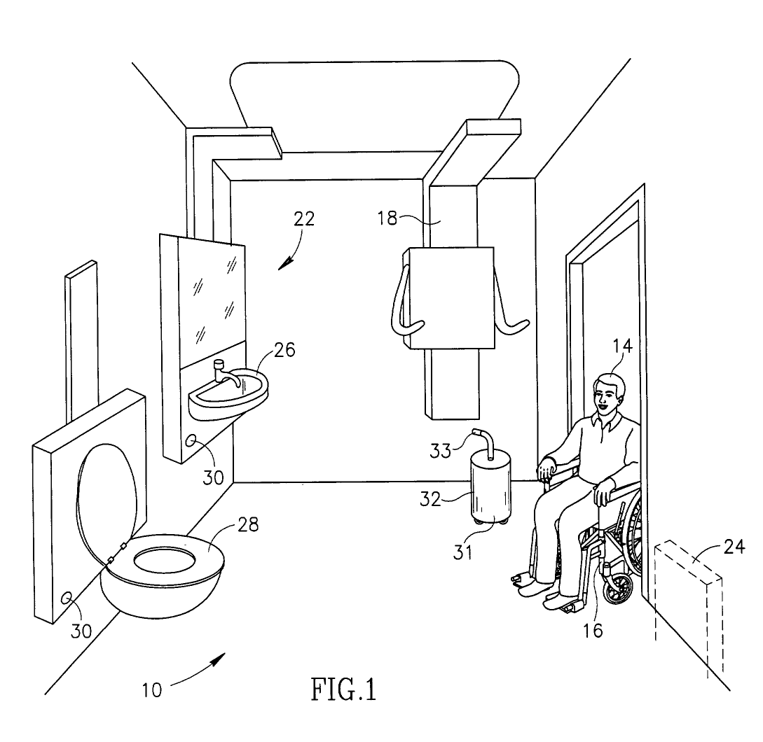

Reference is now made to FIG. 1, which illustrates a healthcare system 10, constructed and operative in accordance with an embodiment of the present invention.

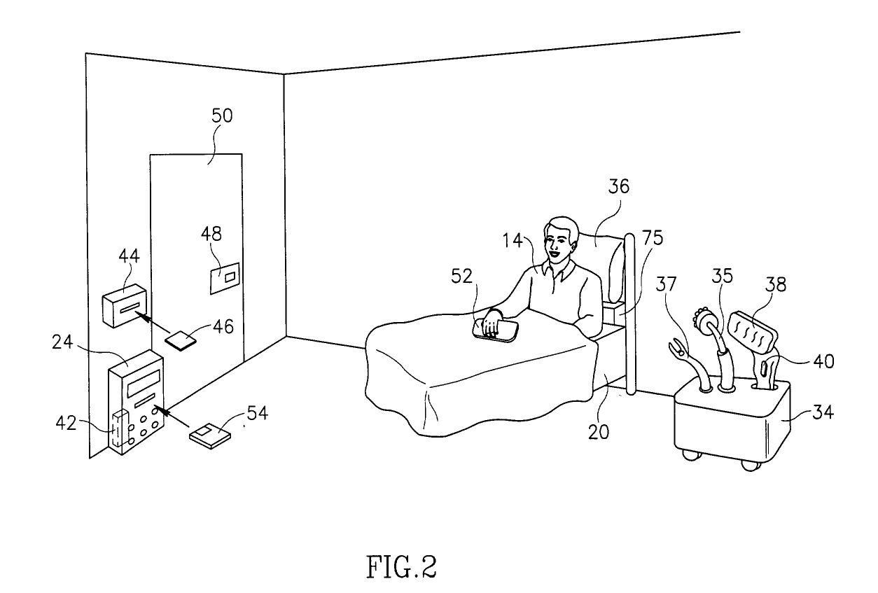

Healthcare system 10 may comprise one or more patient transporters 12 adapted to move a patient 14, such as a physically challenged patient. Patient transporter 12 may comprise, without limitation, a wheelchair 16 or other ground vehicle, wall or ceiling-mounted patient manipulator 18 or a movable bed 20 (FIG. 2), for example. System 10 may also include one or more patient assist devices 22 that may perform one or more actions that assist patient 14. Patient assist device 22 may be a multi-purpose device capable of many different operations or a simpler device dedicated to one or two functions only. Examples of patient assist devices are described hereinbelow.

Healthcare system 10 may comprise a controller 24 in communication with patient transporter 12 and patient assist device 22. Controller 24 may coordinate interaction of patient transporter 12 with patient assist device 22. Controller 24 may comprise, without limitation, a small microprocessor, a PC (personal computer), a mainframe computer or a server accessible through the Internet, for example. Controller 24 may reside physically near the patient transporter 12 and patient assist device 22 or may be remotely located and accessed by wired or wireless communication. Patient transporter 12 and patient assist device 22 may comprise appropriate sensors that communicate and work with controller 24 in a close loop control system to provide user-friendly control over healthcare system 10.

In the exemplary embodiment illustrated in FIG. 1, healthcare system 10 may comprise a rest room assembly, which includes one or more movable sanitary fixtures, such as but not limited to, a movable sink 26 and a movable toilet 28. Alternatively, either the sink 26 or toilet 28, or both, may be stationary. Both sink 26 and toilet 28 may be moved vertically and horizontally, for example. Both sink 26 and toilet 28 may comprise a sensor 30 which may sense the position of patient 14 relative to the particular sanitary fixture. Sensor 30 may comprise part of a closed loop control system with controller 24, wherein sensor 30 senses the position of patient 14, sends the sensed spatial information to controller 24 and controller 24 adjusts the position of the sanitary fixtures to match the needs of the patient 14. For example, the closed loop control system may assist the patient to rise from a wheelchair or other patient transporter 12 and move to toilet 28, afterwards transfer to sink 26, and patient assist device 22 may support the patient while standing before the sink, e.g., support the sides and back of the patient while standing. Controller 24 is shown in FIG. 1 as residing locally just outside the rest room, but may alternatively be located in the rest room or in some remote location or comprise a portable controller held or carried by the patient 14.

Patient assist device 22 may alternatively or further comprise personal hygienic apparatus adapted to perform an action related to patient hygiene. For example, in the exemplary embodiment illustrated in FIG. 1, patient assist device 22 may comprise a robotic cleaning machine 32, capable of cleaning and sanitizing the sanitary fixtures after use thereof. Robotic cleaning machine 32 may comprise a brush head 33 and cleaning and sterilizing fluid stored in a vessel 31, or any other accessory for cleaning and sanitizing the sanitary fixtures.

For example, sink 26 may be moved vertically to adjust to the height of the patient 14. Sink 26 may be moved (e.g., horizontally or tilted) towards patient 14 while sitting, so that patient 14 does not need to rise. In another example, if patient 14 approaches sink 26 while standing, sensor 30 may automatically adjust the position of sink 26 so that patient 14 may sit down next to or in front of sink 26, thereby permitting patient 14 to use other sanitary fixtures with the outmost convenience and remain in close functional proximity to sink 26.

In the exemplary embodiment illustrated in FIG. 2, healthcare system 10 may alternatively or further comprise other patient assist devices 22. For example, patient assist device 22 may comprise a robotic device 34 that has grasping devices 37 and support members 38 for performing various duties, such as but not limited to, at least partially dressing or undressing patient 14 or taking care of patient personal items 36 (e.g., changing linen, propping pillows, etc.), or a washing head 35 for cleaning or washing parts of patient 14. The patient assist devices 22 of the invention (such as but not limited to, wheelchair 16 or robotic device 34) may comprise a support member 38 that supports a load force of patient 14. Support member 38 may, for example, support the back of patient 14 when patient 14 is getting in or out of bed 20, or is standing or sitting in front of sink 26. A sensor 40, such as but not limited to, a load cell, may be provided to sense the load force on support member 38. Sensor 40 may comprise part of a closed loop control system with controller 24, wherein sensor 40 senses the load and controller 24 adjusts the supportive force of support member 38 to match the needs of the patient 14.

For example, robotic device 34 may be employed to lift and support patient 14, while performing various healthcare related activities, such as but not limited to, rearranging pillows or washing the patient's back or other body parts. For example, robotic device 34 may comprise support apparatus 75, which may be built-in or attached to bed 20 (or may be separate from bed 20), which may support the weight of the patient 14, assist the patient 14 to a reclining, sitting or even standing position, and which may help prevent the patient 14 from losing balance. For example, the support members 38 may support patient 14, such as from behind on the patient's back, whether in a sitting or standing position with respect to the bed 20, sink 26 or toilet 28, thereby preventing the patient 14 from losing his/her balance.

As mentioned before, one of the patient assist devices 22 that may be included in healthcare system 10 is washing head 35 for cleaning or washing parts of patient 14. Washing head 35, although shown simplistically, in FIG. 2, together with such elements as controller 24 and related sensors, may be part of a system for providing assistance in performing basic hygienic functions in the bathroom. Such a system may provide a broad range of operations necessary for washing and massaging persons, especially physically challenged patients. The system may shower/wash and massage the patient while he/she is in a sitting or reclining position. The system may comprise washing devices that wrap around the patient, and appropriate sub-systems, which may be required for showering and massaging the entire body and which are brought as close as possible to the appropriate places on the patient's body. Controller 24 may comprise part of a user-interface to control operation of the system, controlling various functions, such as but not limited to, the patient position (sitting, standing or lying down), washing, drying, massaging, summoning additional help from healthcare personnel, prompting commands, etc. The controller function may be important in many aspects of the invention, such as but not limited to, ensuring that the washing and massaging devices do not come too close to the patient body, and providing other safety features. Some controller features are described hereinbelow, although the invention is not limited to these features.

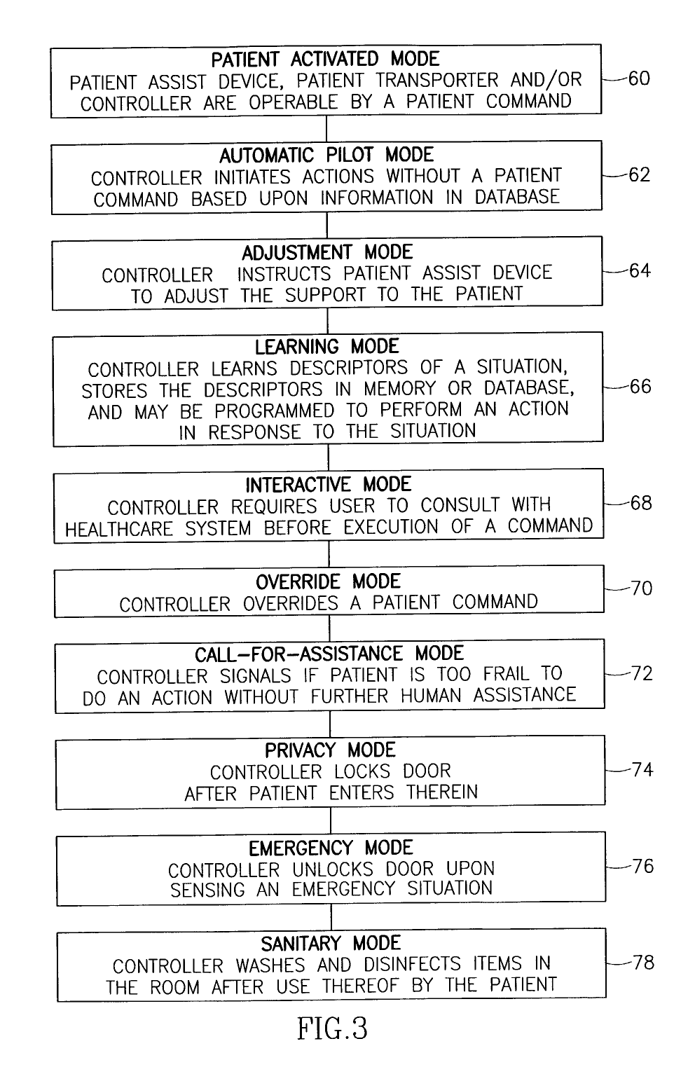

Controller 24 may comprise a database (or memory) 42 of medical and personal behavior information of users of the system 10. A card reader 44 may be provided in communication with controller 24, which may read an identification (ID) card 46 issued to a user of the system 10. ID card 46 may comprise, without limitation, a smart card. The system may permit entry and use only to authorized persons, identified by their ID card 46. For example, as seen in FIG. 2, a door actuator 48 may be provided, which may be operable by ID card 46. Door actuator 48 may permit opening or closing a door 50 only upon authentication of ID card 46. The database 42 may be updated by means of ID card 46, or vice versa. (Persons who may have difficulty inserting a card may have other ID devices, such as but not limited to, pressing buttons with a personal ID code.) Instructions to operate system 10 (for example, instructions for patient transporter 12, patient assist device 22 or controller 24) may be provided by a patient command, such as but not limited to, a physically activated command (e.g., inserting ID card 46 into card reader 44, or pressing buttons of a remote control 52) or a voice activated command. A storage medium 54, such as but not limited to, a floppy disk, hard disk, compact disk or memory chip, may be provided for storing the instructions that enable controller 24 to coordinate interaction of patient transporter 12 with patient assist device 22, in the various modes of operation, examples of which are described hereinbelow with reference to FIG. 3. The interaction between the patient 14 and the system 10 (e.g., by means of ID card 46, remote control 52 or storage medium 54) may enable maneuvering patient 14 to and from the rest room or bedroom or into and out of wheelchair 16, for example.

Reference is now made to FIG. 3, which illustrates examples of modes of operation of controller 24 and system 10. In one embodiment of the invention, controller 24 may have a patient activated mode 60, wherein patient assist device 22, patient transporter 12 and/or controller 24 are operable by a patient command, e.g., voiced or physical commands from the patient. Controller 24 may have an automatic pilot mode 62, wherein controller 24 initiates actions without a patient command, based upon information in database 42. In automatic pilot mode 62, healthcare system 10 may be sensitive to the current situation and operate accordingly even without a patient command.

Additionally, controller 24 may comprise an adjustment mode 64, wherein controller 24 instructs patient assist device 22 to adjust the support to the patient 14 in accordance with the sensed load force, or to adjust the position of the sanitary fixture in accordance with the patient's needs.

Controller 24 may comprise a learning mode 66, wherein controller 24 learns descriptors of a situation, stores the descriptors in memory or database 42, and may be programmed to perform an action in response to the situation. For example, system 10 may be programmed to perform a daily morning routine, comprising helping patient 14 out of bed 20, move to the rest room, use toilet 28, wash up at sink 26, and return to bed 20.

Controller 24 may comprise an interactive mode 68, wherein controller 24 requires a user to consult with healthcare system 10 before execution of a command. For example, the patient 14 or a healthcare provider (not shown) may issue a command to controller 24 and controller 24 may prompt the user with a query for further information. For example, controller 24 may query the patient 14 if the pillow has been adjusted sufficiently or if the patient 14 would like a glass of water.

Controller 24 may comprise an override mode 70, wherein controller 24 may override a patient command. In this mode, the system 10 may be sensitive to the permissibility of certain operations in certain situations, and override the patient's commands. For example, if the patient pushes a wrong button on remote control 52, or would like to perform an operation that does not match his/her physical capabilities, or issues a voice command physically inconsistent with the current situation, the system 10 may override and not carry out the command to avoid damage to the patient 14 or system 10.

Controller 24 may comprise a call-for-assistance mode 72, wherein controller 24 signals if patient 14 is too frail to do an action without further human assistance. For example, the healthcare system 10 may inform the patient 14, such as by a voice message, that the requested action may require human assistance. The healthcare system 10 may itself summon the human assistance. Human personnel would then decide how to proceed.

Controller 24 may comprise a privacy mode 74, wherein controller 24 locks the door 50 after patient 14 enters therein. Controller 24 may further comprise an emergency mode 76, wherein controller 24 unlocks door 50 upon sensing an emergency situation. For example, in an implementation of the healthcare system 10 for a rest room, the system may automatically close the rest room entrance door 50 and not allow another person in, unless healthcare system 10 detects a medical or life-threatening emergency. Upon the user's exit, system 10 may close and/or lock door 50, and reset the system's components. Controller 24 may also comprise a sanitary mode 78, wherein controller 24 washes and disinfects items in the room after use thereof by the patient 14. In this mode of operation, the rest room may appear as an ordinary rest room for standard use. In this manner, the system may avoid embarrassment and discomfort for the physically challenged patients.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A healthcare system comprising:
a patient transporter adapted to move a patient;
a patient assist device adapted to perform an assistive action for a physically challenged patient; and
a controller in communication with said patient transporter and said patient assist device, adapted to coordinate interaction of said patient transporter with said patient assist device.

2. The system according to claim 1, wherein said patient assist device comprises personal hygienic apparatus adapted to perform an action related to patient hygiene, comprising at least one of dressing a patient, undressing a patient, cleaning at least a portion of a patient, and taking care of patient personal items.

3. The system according to claim 1, wherein said patient assist device comprises a movable sink.

4. The system according to claim 3, wherein said sink is movable vertically and horizontally.

5. The system according to claim 3, wherein said sink comprises a sensor adapted to sense a position of a patient relative to said sink.

6. The system according to claim 1, wherein said patient assist device comprises a movable toilet.

7. The system according to claim 6, wherein said toilet is movable vertically and horizontally.

8. The system according to claim 6, wherein said toilet comprises a sensor adapted to sense a position of a patient relative to said toilet.

9. The system according to claim 1, wherein said patient assist device comprises a support member adapted to support a load force of a patient.

10. The system according to claim 9, further comprising a sensor adapted to sense the load force on said support member.

11. The system according to claim 10, wherein said controller comprises an adjustment mode wherein said controller instructs said patient assist device to adjust the support to the patient in accordance with the sensed load force.

12. The system according to claim 1, wherein at least one of said patient assist device, said patient transporter and said controller is operable by a patient command.

13. The system according to claim 12, wherein said patient command comprises a physically activated command.

14. The system according to claim 12, wherein said patient command comprises a voice activated command.

15. The system according to claim 1, wherein said controller comprises a learning mode wherein said controller learns descriptors of a situation, stores the descriptors in memory, and is programmable to perform an action in response to the situation.

16. The system according to claim 1, wherein said controller comprises an interactive mode wherein said controller requires a user to consult with said healthcare system before execution of a command.

17. The system according to claim 1, wherein said controller comprises an override mode wherein said controller overrides a patient command.

18. The system according to claim 1, wherein said controller comprises a call-for-assistance mode, wherein said controller signals if a patient is too frail to do an action without further human assistance.

19. The system according to claim 1, wherein said controller comprises a database of medical and personal behavior information of users of said system.

20. The system according to claim 19, wherein said controller comprises an automatic pilot mode wherein said controller initiates actions without a patient command, based upon information in said database.

21. The system according to claim 1, further comprising an identification card of a user, and a card reader adapted to read said identification card and coupled to said controller.

22. The system according to claim 1, wherein said patient assist device comprises a door actuator operative to open or close a door.

23. The system according to claim 22, wherein said controller comprises a privacy mode wherein said controller locks a door to a room after a patient enters therein.

24. The system according to claim 23, wherein said controller comprises an emergency mode wherein said controller unlocks the door upon sensing an emergency situation.

25. The system according to claim 23, wherein said controller comprises a sanitary mode wherein said controller washes and disinfects items in the room after use thereof by the patient.

26. An article comprising:
a storage medium for storing instructions that enable a controller to coordinate interaction of a patient transporter with a patient assist device, said patient transporter being adapted to move a patient, and said patient assist device being adapted to perform an assistive action for a physically challenged patient.

27. The article according to claim 26, wherein said instructions comprise instructions to perform an action related to patient hygiene, comprising at least one of dressing a patient, undressing a patient, cleaning at least a portion of a patient, maintaining bedding articles and maintaining toiletry articles.

28. The article according to claim 26, wherein said instructions comprise instructions to move a movable sink with respect to a position of a patient.

29. The article according to claim 26, wherein said instructions comprise instructions to move a movable toilet with respect to a position of a patient.

30. The article according to claim 26, wherein said instructions comprise instructions to adjust an amount of support being provided to support a load force of a patient.

31. The article according to claim 26, wherein said instructions comprise instructions executable by a patient command.

32. The article according to claim 26, wherein said instructions comprise instructions executable by a physically activated command.

33. The article according to claim 26, wherein said instructions comprise instructions executable by a voice activated command.

34. A rest room assembly comprising:
a patient transporter adapted to move a patient;
a movable sanitary fixture; and
a controller in communication with said patient transporter and said movable sanitary fixture, adapted to coordinate interaction of said patient transporter with said movable sanitary fixture.

35. The assembly according to claim 34, wherein said movable sanitary fixture comprises a movable sink.

36. The assembly according to claim 35, wherein said sink is movable vertically and horizontally.

37. The assembly according to claim 35, wherein said sink comprises a sensor adapted to sense a position of a patient relative to said sink.

38. The assembly according to claim 34, wherein said movable sanitary fixture comprises a movable toilet.

39. The assembly according to claim 38, wherein said toilet is movable vertically and horizontally.

40. The assembly according to claim 38, wherein said toilet comprises a sensor adapted to sense a position of a patient relative to said toilet.

41. The assembly according to claim 34, wherein said movable sanitary fixture comprises a support member adapted to support a load force of a patient.

42. The assembly according to claim 41, further comprising a sensor adapted to sense the load force on said support member.

43. The assembly according to claim 42, wherein said controller comprises an adjustment mode wherein said controller instructs said movable sanitary fixture to adjust the support to the patient in accordance with the sensed load force.

44. The assembly according to claim 34, wherein at least one of said movable sanitary fixture and said controller is operable by a patient command.

45. The assembly according to claim 44, wherein said patient command comprises a physically activated command.

46. The assembly according to claim 44, wherein said patient command comprises a voice activated command.

47. The assembly according to claim 34, wherein said controller comprises a learning mode wherein said controller learns descriptors of a situation, stores the descriptors in memory, and is programmable to perform an action in response to the situation.

48. The assembly according to claim 34, wherein said controller comprises an interactive mode wherein said controller requires a user to consult with said healthcare system before execution of a command.

49. The assembly according to claim 34, wherein said controller comprises an override mode wherein said controller overrides a patient command.

50. The assembly according to claim 34, wherein said controller comprises a call-for-assistance mode, wherein said controller signals if a patient is too frail to do an action without further human assistance.

51. The assembly according to claim 34, wherein said controller comprises a database of medical and personal behavior information of users of said system.

52. The assembly according to claim 51, wherein said controller comprises an automatic pilot mode wherein said controller initiates actions without a patient command, based upon information in said database.

53. The assembly according to claim 34, further comprising an identification card of a user, and a card reader adapted to read said identification card and coupled to said controller.

54. The assembly according to claim 34, further comprising a door actuator operative to open or close a door of a room in which said movable sanitary fixture is located.

55. The assembly according to claim 54, wherein said controller comprises a privacy mode wherein said controller locks a door to a room after a patient enters therein.

56. The assembly according to claim 55, wherein said controller comprises an emergency mode wherein said controller unlocks the door upon sensing an emergency situation.

57. The assembly according to claim 55, wherein said controller comprises a sanitary mode wherein said controller washes and disinfects items in the room after use thereof by the patient.
